(19) United States
(12) Patent Application Publication
(10) Pub. No.: US 2004/0229678 A1
(43) Pub. Date: Nov. 18, 2004

(54) Gaming machine and method of controlling the same

(75) Inventors: Yoshikazu Onuki, Tokyo (JP); Kaoru Watanabe, Tokyo (JP); Takao Sasazaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KONAMI CORPORATION

(21) Appl. No.: 10/401,541

(22) Filed: Mar. 31, 2003

(30) Foreign Application Priority Data
May 8, 2002 (JP) P2002-133273

(51) Int. Cl. A63F 13/00

(52) U.S. Cl. 463/20

(57) ABSTRACT

In a gaming machine, there are provided a plurality of rotatable reels. Each of the reels is provided with a plurality of symbols. The reels are looked through a window. An electro-optical member is disposed between the window and the reels, the electro-optical member being transparent with respect to visible light, but operable to display an electro-optical image in accordance with an electric signal supplied thereto. A controller controls the electric signal thereby controlling the electro-optical image to be displayed in the electro-optical member.

### BACKGROUND OF THE INVENTION

The present invention relates to a gaming machine having reels to be used for displaying symbols, as well as to a method for controlling such a gaming machine.

A slot machine usually comprises three reels, three reel stop buttons assigned to the respective reels, and a start lever to be used for starting a game. When a player lowers the start lever, all reels start spinning simultaneously. At timings at which the player has pressed the reel stop buttons, the reels come to a halt. Among combinations of symbols displayed in reel windows while the reels remain stationary, a combination of symbols which imparts a gaming value is called a winning combination. When a combination of symbols that constitutes a winning combination is displayed, a win arises. Upon occurrence of a win, a player can acquire tokens in a number determined on the basis of the winning combination by which the win has been determined.

Here, a win is determined in two steps. A first step is called internal lottery. In relation to internal lottery, random number selection is performed at a timing at which the start lever is actuated, to thereby determine a prize group in which a win is to be determined or a failure. Internal lottery information showing a result of random number selection is generated. Namely, a one-to-one correspondence arises between a prize group and a winning combination, or a plurality of winning combinations may correspond to one prize group.

In a second step, positions at which reels are to be stopped are controlled in accordance with actuation of the reel stop buttons. In a case where the internal lottery information represents a failure, even when a player has actuated reel stop buttons at a timing when symbols that would constitute a certain winning combination approach a valid payline, a control operation is performed such that timings at which the reels are to be stopped are delayed, to thereby hinder the symbols from being displayed in the reel window.

In contrast, in a case where a win has been determined for a certain prize group through internal lottery, even when the player has actuated the reel stop buttons at slightly earlier timings, a draw-in control operation is performed such that symbols that would constitute a winning combination corresponding to a prize group come to the reel window. However, when the reel stop buttons are actuated at greatly-shifted timings, a win does not arise. In other words, in order to acquire a win, the player must acquire a win for a certain prize group and align, in the reel window, symbols that constitute a winning combination corresponding to the thus-determined prize group.

Incidentally, a slot machine performs a presentation by utilization of internal lottery information. Typical presentation is to display on an auxiliary display device such as a liquid-crystal display device or display an animation representing occurrence of a win for a BB prize, such that characters representing a prize group for which a win has been determined on the basis of internal lottery information are displayed on the liquid-crystal display device. Another typical presentation is to display various kinds of characters on mechanical reels, to thereby spin the reels.

Incidentally, the number of tokens to be paid to the player is determined on the basis of the kind of a winning combination. While playing a game, the player focuses his/her attention on spinning/stopping actions of the reels appearing through the reel windows. The auxiliary display section is mounted at a position distant from the reel windows, such as a position on an upper part of the slot machine or a position to the right of the reel window.

In order to see an image appearing on the auxiliary display section, the player must shift his/her gaze to the auxiliary display section quite often. Further, a method of game presentation has a tendency toward complication. Hence, on a recent slot machine the player shifts his/her gaze more frequently. For this reason, there arises a problem of the player suffering eyestrain after having continuously played a game for a certain period of time, thereby making it impossible for the player to play a game for a long period of time.

The auxiliary display section does not contribute to occurrence of a win and hence is not worth its cost.

In a related-art slot machine, symbols appearing through the reel windows are printed on belts of the respective reels and remain stationary on the belts. The belts are merely spun, thus providing the player with a sense of monotony.

### SUMMARY OF THF INVENTION

It is therefore an object of the invention to provide a slot machine which enables a player to enjoy playing a game for a long period of time.

In order to achieve the above object, according to the invention, there is provided a gaming machine, comprising:

a plurality of rotatable reels, each provided with a plurality of symbols;

a window, through which the reels are looked;

an electro-optical member, disposed between the window and the reels, the electro-optical member being transparent with respect to visible light, but operable to display an electro-optical image in accordance with an electric signal supplied thereto; and

a controller, which controls the electric signal thereby controlling the electro-optical image to be displayed in the electro-optical member.

In such a configuration, since the electro-optical member has a transparency, the player can observe the symbols on the reels through the electro-optical member. Further, since the electro-optical member is interposed between the reels and the player, an image appears along an extension of the player's line of sight during the course of a game. Consequently, the player does not need to shift his/her gaze. As a result, the player can enjoy playing games for a long time period without experiencing eyestrain.

Preferably, the electro-optical member comprises a pair of transparent substrate between which an electro-optical substance is sandwiched.

The electro-optical substance signifies a substance whose optical characteristic can be controlled by electricity, and encompasses electro luminescence (hereinafter abbreviated as EL) or liquid crystal whose transparency changes in accordance with a voltage. The electro-optical member corresponds to, e.g., an EL panel or a liquid-crystal panel. Further, transparency signifies transparency or translucency of, at least, an image non-display region.

Preferably, the electro-optical image includes gaming information generated in accordance with a proceeding condition of a game performed in the gaming machine.

For example, in a case where the gaming machine is a slot machine, the image includes the number of tokens to be paid and validated winning lines. Such game information is useful for the player to advance a game and is displayed on the electro-optical member interposed between the reels and the player. Consequently, the player can ascertain game information without shifting his/her gaze.

Preferably, the gaming machine further comprises an illuminator, which illuminates the reels under with at least a first luminosity and a second luminosity darker than the first luminosity. The illuminator illuminates the reels with the second luminosity when the electro-optical image is displayed in the electro-optical member.

In such a configuration, the displayed electro-optical image is rendered easy to see.

Preferably, the gaming machine further comprising a detector, which detects a position of at least one of the symbols on at least one of the reels looked through the window. The controller controls the electro-optical image in accordance with the detected position.

In such a configuration, the symbols on the reels can be associated with the image to be displayed on the electro-optical member. Hence, presentation that is interesting to the player can be provided.

Here, it is preferable that the electro-optical image shows at least one reel rotated in accordance with the detected position in a case where the at least one of the reels is stationary.

In such a configuration, switching to display of the electro-optical member may be effected once the reels have come to a halt, and an image of spinning of virtual reels may be displayed. Hence, a big surprise is provided to the player, thus imparting a strong impact to the player.

It is alternatively preferable that the electro-optical image shows transformation of the detected symbol into another symbol in accordance with the detected position, In such a configuration, the detected symbol may be changed after the reels have temporarily come to a halt and switching to the display of the electro-optical member has been effected. Hence, a big surprise is provided to the player, thus imparting a strong impact to the player. Here, the detected symbol may constitute a big bonus prize.

It is also provided that: the controller comprises a first controller and a second controller; and the first controller generates information regarding the detected symbol and transmits the information to the second controller so that the second controller controls the electro-optical image.

For instance, in a case where the gaming machine corresponds to a slot machine, the first controller corresponds to a main board which acts as a control center of the entire slot machine. A CPU of the main board serves the chief role of the first controller. The second controller corresponds to a sub-board which controls the electro-optical member or the like. A CPU of the sub-board serves the chief role of the second controller.

When advanced presentation is provided through use of the electro-optical member, the main board and the sub-board preferably share processing, because the processing capability of the main board is limited. As a result of processing being shared between the first and second controllers, an attempt can be made to improve productivity. Specifically, ROM for the main board has been mass-produced in advance. By replacing ROM of sub-boards in accordance with the type of a gaming machine, contents of a game can be changed.

Here, it is further preferable that the first controller generates information regarding the detected position and transmits the information to the second controller so that the electro-optical image shows at least one reel rotated in accordance with the detected position, in a case where at least one of the reels is stationary.

It is alternatively preferable that the first controller generates information regarding the detected position and transmits the information to the second controller so that the electro-optical image shows transformation of the detected symbol into another symbol in accordance with the detected position.

It is also preferable that the position is detected with reference to a rotation angle of the at least one reel. In such a configuration, an image can be displayed on the electro-optical member in synchronism with actual spinning operation of the reels. The rotation angle may be detected by combining drive pulses used for driving the reels with a pulse synchronized with the spinning cycle of each of the reels.

It is also preferable that: the controller comprises a first controller and a second controller; and the first controller generates information regarding the rotation angle and transmits the information to the second controller so that the second controller controls the electro-optical image.

According to the invention, there is also provided a method of controlling a gaming machine, comprising step of:

providing a gaming machine which comprises:

a plurality of rotatable reels, each provided with a plurality of symbols;

a window, through which the reels are looked; and

an electro-optical member, disposed between the window and the reels, the electro-optical member being transparent with respect to visible light, but operable to display an electro-optical image in accordance with an electric signal supplied thereto;

detecting a proceeding condition of a game performed in the gaming machine; and

controlling the electric signal in accordance with the detected proceeding condition, thereby controlling the electro-optical image to be displayed in the electro-optical member.

Preferably, the method further comprises step of: providing an illuminator in the gaming machine, the illuminator being operable to illuminate the reels under with at least a first luminosity and a second luminosity darker then the first luminosity; and controlling the illuminator so as to illuminate the reels with the second luminosity when the electro-optical image is displayed in the electro-optical member.

Preferably, the gaming machine further comprising steps of: detecting a position at least one of the symbols on at least one of the reels looked through the window; and controlling the electro-optical image in accordance with the detected position.

### BRIEF DESCRIPTION OF THE DRAWINGS

The above objects and advantages of the present invention will become more apparent by describing in detail preferred exemplary embodiments thereof with reference to the accompanying drawings, wherein;

FIG. 1 is a perspective view showing the external appearance of a slot machine according to an embodiment of the invention;

FIG. 2 is a perspective view showing the structure of reels and a peripheral configuration thereof;

FIG. 3 is a descriptive view schematically showing a mechanical configuration of a panel display section in the slot machine;

FIG. 4 is a cross-sectional view of the panel display section shown in FIG. 3 taken along line Z1-Z2;

FIG. 5 is a descriptive view showing an example of symbols to be displayed on reels in the panel display section;

FIG. 6 is a block diagram showing an electrical configuration of the slot machine;

FIG. 7 is a descriptive view showing an example of details of a prize group lottery table;

FIG. 8 is a flowchart showing operation of a CPU during internal lottery operation;

FIG. 9 is a descriptive view showing an example of a stop table;

FIG. 10 is a block diagram showing the configuration of a display controller; and

FIG. 11 is a timing chart showing a relationship between a detection signal, a symbol number, a drive signal, and position data.

### DETAILED DESCRIPTION OF THE PREFERRED EMBODIMENTS

Embodiments of the invention will be described hereinbelow by reference to the accompanying drawings. Here, an explanation is given of a case where the invention is applied to a slot machine.

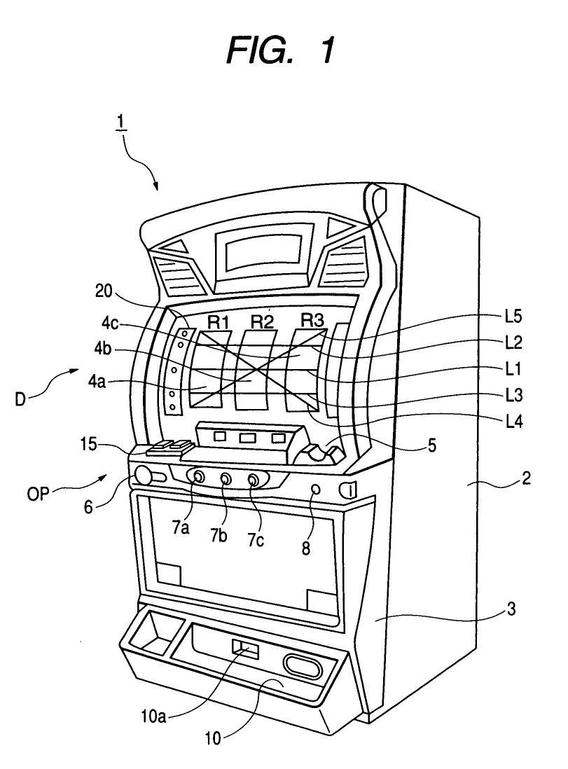

As shown in FIG. 1, a slot machine 1 according to a first embodiment of the invention comprises a main unit 2 and a front door 3 attached to the front of the main unit 2. An EL (electro-luminescence) display panel 80 for providing a player with predetermined information is provided at an upper portion of the front door 3, A panel display section D disposed at a middle portion of the front door 3 has three vertically-oriented rectangular display windows 4a, 4b, and 4c. The display windows 4a, 4b, and 4c are formed from transparent material; e.g., acrylic resin. Three horizontal paylines L1 through L3 and two inclined paylines L4 and L5 are provided across the display windows 4a, 4b, and 4c.

In addition, an auxiliary display section 20 is provided on the left side of the display window 4a. The auxiliary display section 20 comprises five LEDs assigned to the respective paylines L1 through L5. When a player inserts tokens or performs a betting operation to be described later, one or more of the paylines L1 through L5 are made valid, in a number corresponding to the number of tokens bet. In the slot machine 1, when one token is bet, the payline L1 becomes valid. When two tokens are bet, the paylines L1 through L3 become valid. When three tokens are bet, the paylines L1 through L5 become valid. LEDs constituting the auxiliary display section 20 are illuminated when corresponding paylines L1 through L5 are valid. In contrast, the LEDs become extinguished when the corresponding paylines L1 through L5 are invalid. Thus, the player can ascertain valid lines from among the paylines L1 through L5.

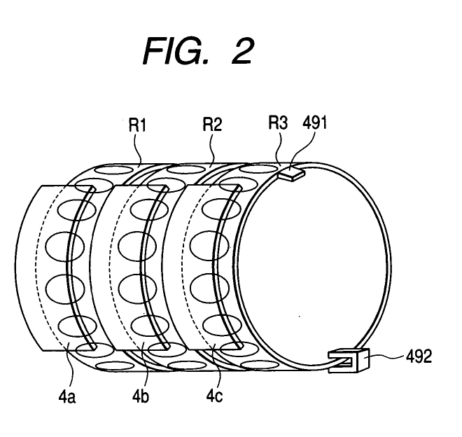

FIG. 2 shows the structure of the panel display section D and a peripheral configuration thereof. Three rows of reels, on whose outer peripheral faces a plurality of kinds of symbols are drawn; that is, a left reel R1, a center reel R2, and a right reel R3, are rotatably disposed at the inside of the respective display windows 4a, 4b and 4c. A shading piece 491 projects from a portion of a reel main body of the right reel R3. When the right reel R3 spins, the shading piece 491 runs across a photo coupler 492. As in the case of the right reel R3, the shading piece 491 and the photocoupler 492 are provided on each of the left reel R1 and the center reel R2.

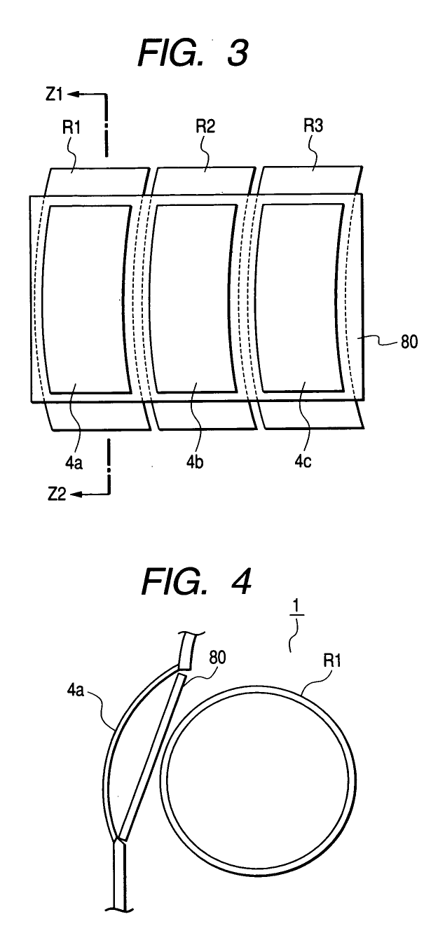

FIG. 3 is a descriptive view schematically showing mechanical constitution of a panel display section D in the slot machine 1B, and FIG. 4 is a cross-sectional view of the panel display section D shown in FIG. 3 taken along line Z1-Z2.

As illustrated, the EL display panel 80 assumes a flat shape and is interposed between the display window 4a and the left reel R1, between the display window 4b and the center reel R2, and between the display window 4c and the right reel R3. The edge of the EL display panel 80 is fastened to the front door 3 (see FIG. 1).

The EL display panel 80 is constructed from EL material sandwiched between first and second substrates. The first and second substrates are transparent, and transparent electrodes are formed on corresponding surfaces of the substrates. Upon receipt of a feed of electric current, the EL material illuminates. When the feed of current is stopped, the EL material becomes transparent. A plurality of pixels are arranged in the EL display panel 80 in the form of a matrix pattern, and a variety of images can be displayed on the EL display panel 80. Since the EL display panel 80 becomes transparent without receipt of a feed of electric current, in such a state the player can observe the statuses of the respective reels R1, R2, and R3 via the display windows 4a, 4b, and 4c.

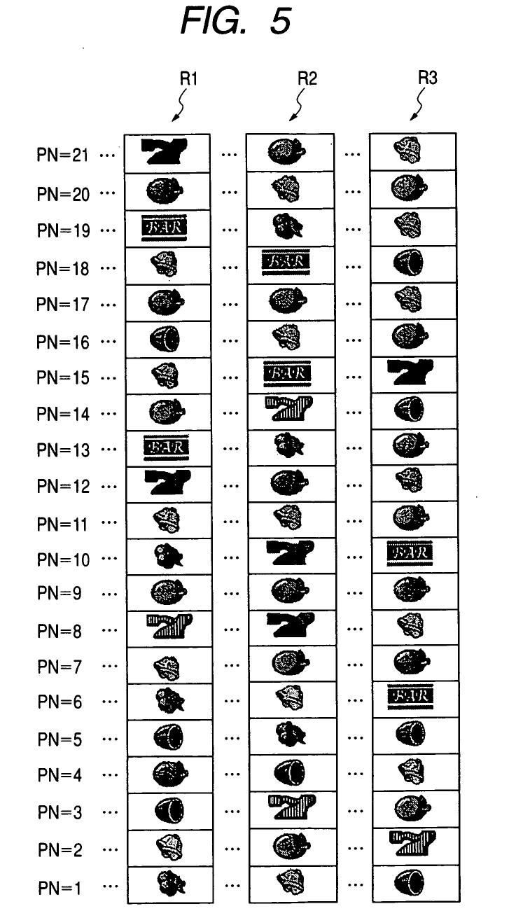

FIG. 5 shows example symbols to be displayed on the left reel R1, those to be displayed on the center reel R2, and those to be displayed on the right reel R3. As illustrated, the symbols are appended symbol numbers PN=1 to 21. Here, a solid “7” depicts a red “7” (e.g., a symbol appended PN=21 on the left reel), and a hatched “7” depicts a blue “7” (e.g., a symbol appended PN=14 on the center reel).

In a play to be performed by the slot machine 1, when a predetermined combination of symbols is aligned with any of the paylines L1 through L5 that has been made valid by insertion of tokens, tokens are ejected in a number corresponding to the winning combination. Tokens are to be inserted into the slot machine 1 before start of a game. Further, tokens are required for a player to continue playing games. In short, tokens can be said to be a medium having a gaming value, such as continuation of a game.

In the following description, from among combinations of symbols, a combination of symbols that would impart gaming values is called a “winning combination,” and a combination of symbols that is worthless is called a “failure.” The present embodiment employs the following winning combinations.

1) RED 7 winning combination is a combination of a symbol appended symbol number PN=21 or 12 on the left reel R1, a symbol appended symbol number PN=10 or 8 on the center reel R2, and a symbol appended symbol number PN=15 on the right reel R3.

2) BLUE 7 winning combination is a combination of a symbol appended symbol number PN=8 on the left reel R1, a symbol appended symbol number PN=14 or 3 on the center reel R2, and a symbol appended symbol number PN=2 on the right reel R3.

3) BAR winning combination is a combination of a symbol appended symbol number PN=13 or 19 on the left reel R1, a symbol appended symbol number PN=18 or 15 on the center reel R2, and a symbol appended symbol number PN=10 or 6 on the right reel R3.

4) BELL winning combination is a combination of a symbol appended symbol number PN=7, 11, 15, or 18 on the left reel R1, a symbol appended symbol number PN=6, 11, 16, or 20 on the center reel R2, and a symbol appended symbol number PN=4, 8, 12, 17, 19 or 21 on the right reel R3. The BELL winning combination offers a payout of seven tokens.

5) WATERMELON winning combination is a combination of a symbol appended symbol number PN=3, 5, or 16 on the left reel R1, a symbol appended symbol number PN=4 on the center reel R2, and a symbol appended symbol number PN=1, 5, 14, or 18 on the right reel R3. The WATERMELON winning combination offers a payout of 15 tokens.

6) CHERRY winning combination is established when any one of the symbols appended symbol numbers PN=1, 6, and 10 on the left reel R1 has stopped at a validated payline of the paylines L1 through L5, and stop positions of the other reels are irrelevant to this combination. The CHERRY winning combination yields a payout of two tokens.

7) PLUM winning combination is a combination of a symbol appended symbol number PN=4, 9, 14, 17, or 20 on the left reel R1, a symbol appended symbol number PN=2, 7, 9, 12, 17, or 21 on the center reel R2, and a symbol appended symbol number PN=3, 7, 9, 11, 13, 16, or 20 on the right reel R3. Even when a PLUM winning combination has been established, tokens are not paid out; however, the player can play a replay game. Here, a replay game means that a player can again play a game without insertion of new tokens.

In relation to these winning combinations, gaming values to be afforded to a player are determined in advance for each playing state. Winning combinations are divided into a winning combination for affording payout of 1 to 15 tokens; a winning combination for affording an advantageous gaming state, such as a big bonus or a regular bonus, regardless of whether or not tokens are paid for a win; and a winning combination for affording a replay game which enables a player to play a game again under conditions corresponding to insertion of the same number of tokens, Further, not all these winning combinations are always determined as wins in every gaming state; it may be possible for winning combinations to hold a win in a certain gaming state but to not constitute a win in another gaming state. More specifically, gaming values imparted to a player for each win originating from each winning combination are not always constant as previously determined for each gaming state.

In the embodiment, a gaming value to be imparted to players in an ordinary gaming state is seven tokens for the BELL winning combination; 15 tokens for the WATERMELON winning combination; two tokens for the CHERRY winning combination; and a replay game for the PLUM winning combination.

Of various kinds of winning combinations, winning combinations involving relatively low gaming values; e.g., payment of two to 15 tokens or affording of a replay game, as in the case of a BELL winning combination, a WATERMELON winning combination, a CHERRY winning combination, and a PLUM winning combination, are generally called small winning combinations.

When a win is determined through a BAR winning combination, the gaming state shifts to a specific gaming state called a regular bonus (hereinafter abbreviated as “RB,” as required). In the regular bonus state, a jackpot game can be played 12 times. A period of RB expires when the player plays a jackpot game 12 times or achieves a win a maximum of eight times. A jackpot game is played by betting one token, to thereby make only the center payline L1 valid. A PLUM winning combination is adopted as a winning combination for a jackpot game. When symbols that would constitute this winning combination are aligned with the payline L1, the slot machine 1 ejects 15 tokens. In other words, even when a PLUM winning combination is aligned in an ordinary playing state, the player is allowed to play only a replay game. However, in a jackpot game to be played during a period of regular bonus, the player can be awarded 15 tokens when symbols that constitute a PLUM winning combination are aligned.

Further, during a period of big bonus, which will be described later, a PLUM winning combination is allocated to a win to be determined through a regular bonus. In the RG gaming state, a jackpot game which is not available in an ordinary gaming state is provided. The RG gaming state can be said to be advantageous to the player as compared with an ordinary gaming state.

When a win is determined through a BLUE 7 winning combination, a gaming status shifts from an ordinary gaming status to a second special gaming status called a normal big bonus. During the period of big bonus, the player can establish a small winning combination a maximum of 30 times, and can play a regular bonus game a maximum of three times. A normal big bonus game is more advantageous to the player as compared with a regular bonus game.

When a win is determined through a RED 7 winning combination, a gaming status shifts from an ordinary gaming status to a third gaming status called a super big bonus. The super big bonus differs from a normal big bonus in that a small winning combination is reported. As will be described later, in the slot machine 1, when symbols that constitute a winning combination for which a win has been determined through internal lottery are aligned with any of the valid paylines L1 through L5, a win is determined. For this reason, if the player can ascertain a winning combination which has been determined through internal lottery, the player can acquire a larger number of tokens. Reporting of a small winning combination means that the kind of a winning combination which has been determined through internal lottery is reported to the player. Consequently, a super big bonus game is more advantageous to the player as compared with a normal big bonus.

Turning again to FIG. 1, disposed below the display windows 4a, 4b, and 4c is an operation section OP in which are arranged various types of operation members to be used by a player for playing games. The operation section OP has a token insertion slot 5, a start lever 6, a left reel stop button 7a, a center reel stop button 7b, a right reel stop button 7c, a credit button 8, and a RET button 15.

The token insertion slot 5 is provided below the display window 4c and enables insertion of tokens. When one token is inserted, the payline L1 becomes valid. When two tokens are inserted, the paylines L1 through L3 become valid. When three tokens are inserted, the paylines L1 through L5 become valid. Moreover, when the player inserts more than three tokens, the fourth token and subsequent tokens are saved as credits in the slot machine 1.

The BET button 15 is disposed at a lower left position with respect to the display window 4a. The player uses the BET button 15 to specify the number of tokens to be bet in one game. By the player actuating the BET button 15, stored tokens can be bet without insertion of tokens by way of the token insertion slot 5. Therefore, the paylines L1 through L5 become valid, as required, by actuation of the BET button 15 in accordance with the specified number of tokens. The relationship between the number of tokens specified by actuation of the BET button 15 and the paylines L1 through L5 to become valid is identical with that determined in a case where tokens are inserted directly.

The start lever 6 is disposed below the BET button 15. The start lever 6 is used by the player to instruct start of a game. When the player lowers the start lever 6, the reels R1, R2, and R3 start spinning simultaneously, thereby variably displaying symbols within the respective display windows 4a, 4b, and 4c.

The left reel stop button 7a, the center reel stop button 7b, and the right reel stop button 7c are provided on the right side of the start lever 6. The left reel stop button 7a is used for stopping the left reel R1 spinning within the display window 4a; the center reel stop button 7b is used for stopping the center reel R2 spinning within the display window 4b; and the right reel stop button 7c is used for stopping the right reel R3 spinning within the display window 4c.

A credit button 8 to be used for determining whether to store tokens within the slot machine 1 is provided on the right side of the reel stop button 7c. When the player actuates the credit button 8, a change between validation of credits or invalidation of credits is enabled. In a predetermined case, tokens are paid to the player by way of a token payout port 10a and stored in a token receiver 10.

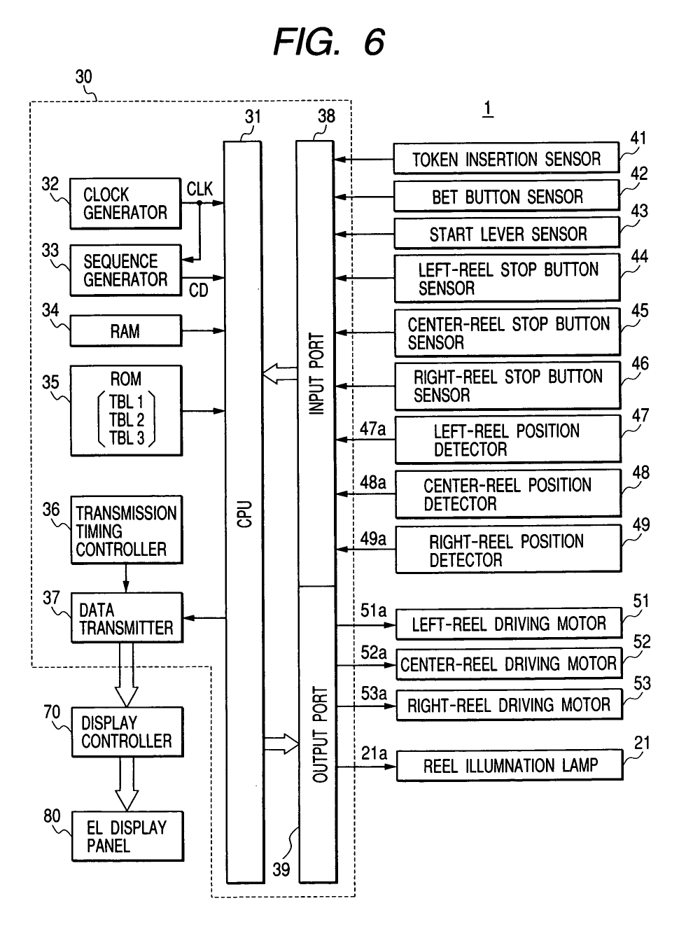

FIG. 6 shows a circuit configuration including a controller for controlling game processing operation in the slot machine 1, and a peripheral device which constitutes the slot machine 1 and is relevant to the invention.

The controller includes a control board 30 as a primary constituent element. The control board 30 has a CPU 31, a clock generator 32, a sequence generator 33, RAM 34, ROM 35, a transmission timing controller 36, a data transmitter 37, an input port 38, and an output port 39.

The CPU 31 is connected to constituent elements of the control board 30 excluding the transmission timing generator 36, by way of a bus (not shown). The CPU 31 controls respective constituent elements by executing a control program CP. A manner of activating the overall slot machine 1 is specified in the control program CP. Therefore, the CPU 31 serves as a control center of the slot machine 1. The clock generator 32 has an oscillation circuit including a quartz generator, generates a reference clock signal CLK of fixed cycle, and supplies the reference clock signal to the CPU 31 and the sequence generator 33.

The sequence generator 33 is constituted of a high-speed ring counter and produces count data CD by counting the reference clock signal CLK Depending on contents of a prize group selection table TBL1 to be described later, the numerical values of the count data CD assume a range of, e.g., 1 to 60000. The count data CD are supplied to the CPU 31 at all times. The CPU 31 senses a timing at which the start lever 6 is pressed by the player. The count data CD are sampled at that timing, thereby producing sampling data SD.

Since the player cannot ascertain the value of the count data CD, the timing at which the player lowers the start lever 6 is random. Consequently, the value of the sampling data SD is also random. The sequence generator 33 operates in synchronism with the reference clock signal CLK. Hence, the cycle of the count data CD is very short. For example, provided that the reference clock signal CLK has a cycle of 30 MHz, a time required for the value of the count data to change from “0” to “59999′ is 2 msec. Consequently, even if the player can ascertain the value of the count data CD by unauthorized means, the player cannot cause the CPU 31 to produce the sampling data SD having a desired value by actuation of the start lever 6.

Next, the RAM 34 serves as a work area of the CPU 31 and stores a result of processing currently in progress or data or the like prepared as required.

In addition to the control program CP, a prize group lottery table TBL1, a stop table group TBL2, and a winning symbol combination table TBL3 are stored in the ROM 35. Stored in the winning symbol combination table TBL3 in an associated manner are combinations of symbols that would constitute a winning combination; the numbers of tokens to be paid at the time the winning combinations arise; and a win determination code representing the winning combination.

As mentioned above, the winning combinations prepared in the slot machine 1 according to the embodiment include a RED 7 winning combination, a BLUE 7 winning combination, a BAR winning combination, a BELL winning combination, a WATERMELON winning combination, a CHERRY winning combination, and a PLUM winning combination. Establishment of the RED 7 winning combination serves as the impetus for shifting a gaming status to a super big bonus. Establishment of the BLUE 7 winning combination serves as the impetus for shifting a gaming status to a normal big bonus Establishment of the BAR winning combination serves as the impetus for shifting a gaming status to a regular bonus.

The gaming values which the player can acquire differ from one kind of small winning combination to another. A control operation corresponding to a difference in gaming values is required for controlling the slot machine 1. Classification of types of winning combinations according to gaming values is convenient. In the following description, an aggregate of various winning combinations is called a prize group.

As mentioned above, the RED 7 winning combination (super big bonus) and the BLUE 7 winning combination (normal big bonus) are identical with each other in terms of progress in a series of games, exclusive of report of a small winning combination. In the slot machine 1 of the embodiment, one prize group is assigned to these winning combinations. A prize group including the RED 7 winning combination and the BLUE 7 winning combination is called a big bonus prize. For the remaining winning combinations, prize groups are prepared so as to correspond to respective winning combinations. A prize group corresponding to the BAR winning combination is called an regular bonus prize; a prize group corresponding to the BELL winning combination is called a BELL prize; a prize group corresponding to the WATERMELON winning combination is called a WATERMELON prize; a prize group corresponding to the CHERRY winning combination is called a CHERRY prize; and a prize group corresponding to the PLUM winning combination is called a REPLAY GAME prize.

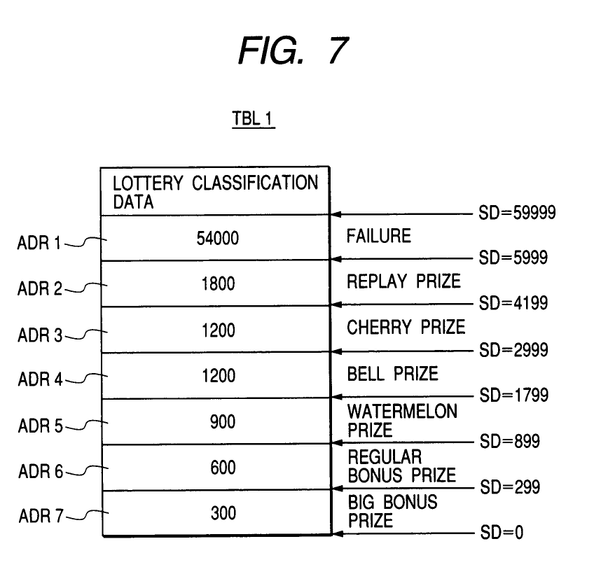

FIG. 7 shows details of the stored prize group lottery table TBL1. As illustrated, the prize group lottery table TBL1 stores sampling category data in first to seventh storage areas ADR1 to ADR7. The values of the sampling category data indicate the sizes of sampling categories corresponding to the respective prize groups. For instance, the sampling category data stored in the first storage area ADR1 are associated with failures and assume a value of “54000”. The sampling category data stored in the seventh storage area ADR7 are associated with the BB prize and assume a value of “300”.

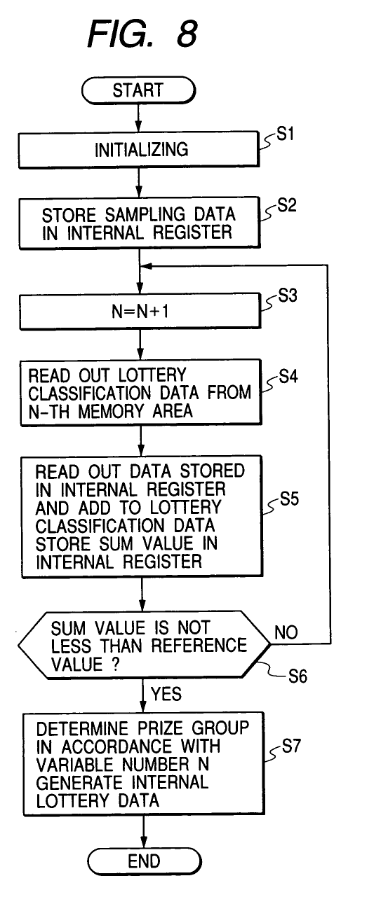

FIG. 8 is a flowchart showing operation of the CPU 31 to be performed during an internal lottery operation through use of the prize group lottery table TBL1. First, the CPU 31 performs an initializing (step S1). More specifically, the value of a variable number N is reset to “0,” and the value stored in the internal register is reset to “0.”

Next, the CPU 31 stores first sampled data SD into an internal register (step S2). Subsequently, the value of the variable number N is changed to (N+1) (step S3). Next, the CPU 31 reads lottery classification data from an n-th memory area (step S4). By processing to be performed immediately after initializing, the value of the variable number is set to “1.” The lottery classification data are read from a first memory area ADR1. In this case, the data assume a value of “54000.”

Next, the CPU 31 reads contents stored in the internal register and adds the thus-read data to the lottery classification data. The resultant sum value is stored in the internal register (step S5). Consequently, the contents of the internal register are updated to the resultant value.

Net, the CPU 31 determines whether the sum value is not less than a reference value (step S6). The reference value is equal to an aggregate of the respective lottery classification data values stored in the first through seventh memory areas ADR1 to ADR7.

If the sum value is less than the reference value, the CPU 31 returns processing to step S3 and repeats processing pertaining to steps S3 to S6 until the sum value becomes greater than the reference value, At this point, the CPU 31 proceeds processing to step S7. A prize group is determined in accordance with the value of the variable number N, thereby generating internal lottery data. More specifically, when N=1, a failure is determined. When N=2, a REPLAY prize is determined. When N=3, a CHERRY prize is determined. When N=4, a BELL prize is determined. When N=5, a WATERMELON prize is determined. When N=6, an RB prize is determined. When N=7, a BB prize is determined. Consequently, a relationship between the first sampled data SD and the prize groups is as shown in FIG. 7. As illustrated, SD=59999 to 6000 corresponds to a failure; SD=5999 to 4200 corresponds to a REPLAY prize; SD=4199 to 3000 corresponds to a CHERRY prize; SD=2999 to 1800 corresponds to a BELL prize; SD=1799 to 900 corresponds to a WATERMELON prize; SD==899 to 300 corresponds to an RB prize; and SD=299 to 0 corresponds to a BB prize.

The CPU 31 produces internal lottery data ISD on the basis of a result of determination. The internal lottery data ISD are 8-bit data, A first bit is allocated to a big bonus prize; a second bit is allocated to an regular bonus prize; a third bit is allocated to a BELL prize; a fourth bit is allocated to a WATERMELON prize; a fifth bit is allocated to a CHERRY prize; and a sixth bit is allocated to a REPLAY prize. If a win has been determined for any one of the prizes through internal random sampling, the CPU 31 sets the digit of a corresponding bit to “1.” When no win has been determined, the digit of a bit is set to “0.” Consequently, it is possible to ascertain whether or not a win has been determined or a prize group for which a win has been determined, by referring to the internal status data ISD.

Next, the stop table group TBL2 is constituted of a plurality of stop tables. In the respective stop tables, symbol numbers PN to be displayed on the center payline L1 and data pertaining to the number of frames over which reels coast (hereinafter simply called “coasting frame data”) are stored in association with each other. Here, the number of frames over which reels coast means the number of frames over which the left reel R1, the center reel R2, and the right reel R3 coast until they come to a halt from the time the player has pressed the left reel stop button 7a, the time the player has pressed the center reel stop button 7b, and the time the player has pressed the right reel stop button 7c, respectively.

Since the left reel R1, the center reel R2, and the right reel R3 spin at high speed, even when the player has actuated the stop buttons while aiming at specific symbols, the player is required to have a skill for stopping the reels such that desired symbols are stopped. Learning of actuation of stop buttons involves variations among individual players. Particularly, a player having a low level of kinetic vision encounters difficulty in stopping the reels such that desired symbols appear. In contrast, a player having a high level of kinetic vision can actuate the stop buttons when desired symbols are displayed along a payline.

However, in order to enable a player having a low level of kinetic vision to enjoy playing games, alignment of symbols must be made easy to a certain extent. In contrast, when the result of internal lottery is a failure, there is a necessity for controlling spinning of the reels such that no winning combination is established.

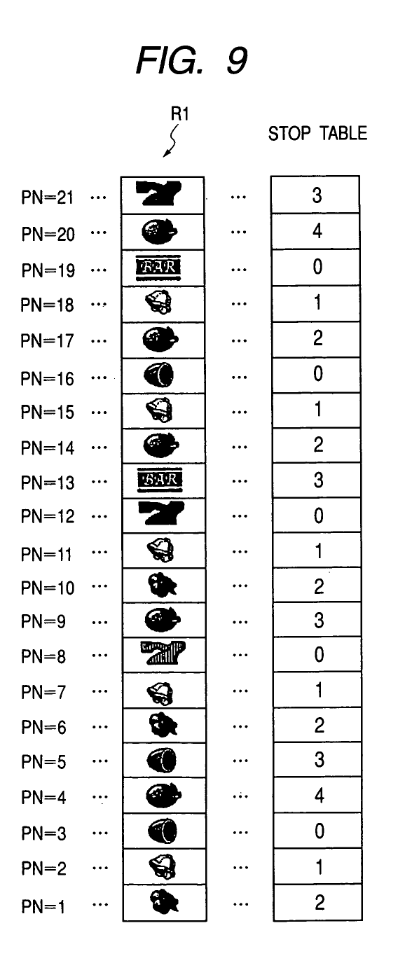

The stop table is used for controlling such spinning actions of the reels. Positions at which the left reel R1, the center reel R2, and the left reel R3 are to be stopped are determined by reference to a stop table. FIG. 9 shows an example of the stop table. The stop table is for the left reel R1. The stop data stored in the stop table are set such that symbols BELL are likely to be stopped at an intersection of the lower payline L3 and the inclined payline L5. For example, a player is assumed to have pressed the left reel stop button 7a at a timing at which a symbol BAR specified by symbol number PN=13 is displayed along the center payline L1. In this case, when the stop table is referred to on the basis of the symbol number PN=13, there are selected coasting frame data in which the number of frames over which a reel coasts assumes three. Consequently, if spinning of the left reel R1 is controlled on the basis of the thus-selected stop data, stopping of BELL symbols (symbol number PN=15) at the intersection of the paylines L3 and L5 will become possible.

Turning back to FIG. 6, description of the controller will be continued. The transmission timing controller 36 and the data transmitter 37 shown in the drawing play the role of transmitting, to the display controller 70, the kind of a winning combination determined through internal lottery and information about a stop table selected in association with the winning combination as a control signal CTL.

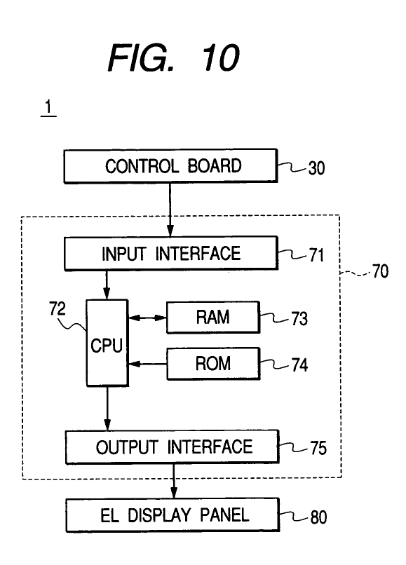

FIG. 10 is a block diagram showing the display controller 70 and the periphery thereof. The display controller 70 comprises an input interface 71, a CPU 72, a RAM 73, a ROM 74, and an output interface 75. The CPU 72 serves as a control center for controlling the overall display controller 70. The RAM 73 serves as a work area of the CPU 72. In addition to the display control program, various kinds of image data are stored in the ROM 74.

According to the foregoing configuration, the CPU 72 displays an image on the EL display panel 80 at a predetermined timing on the basis of the control signal CTL. For instance, the CPU 72 specifies symbols corresponding to the prize group for which a win has been determined, on the basis of the internal sampling data ISD included in the control signal CTL. The CPU 72 reads image data corresponding to the thus-specified symbols from the ROM 74. On the basis of the thus-read image data, the CPU 72 displays a predetermined image on the EL display panel 80.

For example, reporting of a small winning combination to be performed during the course of a super big bonus game is performed, by the CPU 31 transmitting internal status data ISD to the display controller 70 by way of the data transmitter 37; the display controller 70 reading image data corresponding to a winning combination instructed by the internal status data ISD from the ROM 74; and the thus-read image data being supplied to the EL display panel 80.

The input port 38 is an input interface for signals supplied from various types of sensors to be described later. The output port 39 is an output interface for supplying a control signal to motors and various devices.

The following are enumerated as primary input signal generators which are connected to the input port 38 and generate various types of input signals. An token insertion sensor 41 senses tokens inserted by way of the token insertion slot 5 and produces one output pulse for each token. Consequently, the CPU 31 can sense the number of inserted tokens by counting the output pulses.

A BET button sensor 42 senses actuation of the BET button 15. A start lever sensor 43 senses actuation of the start lever 6. A left reel stop button sensor 44 senses actuation of the left reel stop button 7a; a center reel stop button sensor 45 senses actuation of the center reel stop button 7b; and a right reel stop button sensor 46 senses actuation of the right reel stop button 7c. Further, a left reel position detector 47 senses the spinning position of the left reel R1 and produces a detection signal 47a; a center reel position detector 48 senses the spinning position of the center reel R2 and produces a detection signal 48a; and a right reel position detector 49 senses the spinning position of the center reel R2 and produces a detection signal 49a.

The right reel position detector 49 has the photocoupler 492 shown in FIG. 2, an amplifier, and a comparator, The photocoupler 492 has a light-emitting section and a light-receiving section. When the light-receiving section outputs a received light signal of a level corresponding to the quantity of received light, the amplifier amplifies the received light signal. The comparator compares the signal output from the amplifier with a predetermined threshold value, thereby producing the detection signal 49a. The signal is output as an output signal from the right reel position detector 49. When the right reel R1 spins, the shading piece 491 shown in FIG. 2 passes through the photocoupler 492 once during the course of one spin. Consequently, the spinning position of the right reel R3 can be sensed by the detection signal 49a. The left position detector reel 47 and the center position sensor reel 48 are constructed in the same manner as is the right reel position detector 49.

Primary members which are connected to the output pod 39 and receive supply of various output signals include a left reel drive motor 51, a center reel drive motor 52, a right reel drive motor 53, a reel illumination lamp 21.

The left reel driving motor 51 drives the left reel R1 so as to spin; the c enter reel driving motor 52 drives the c enter reel R2 so as to spin; and the right reel driving motor 53 drives the right reel R3 so as to spin. In the embodiment, the driving motors are constituted of stepping motors. Consequently, the CPU 31 can correctly determine a stop position for the left reel R1, that for the center reel R2, and that for the right reel R3 by adjusting the number of pulses of respective drive signals 51a, 52a, 53a to be supplied to the left reel driving motor 51, the center reel driving motor 52, and the right reel driving motor 53, respectively.

Each of the motors 51, 52, 53 is constructed so as to spin once in response to 420 pulses. As mentioned above, 21 symbols are formed on each of the reels R1, R2, and R3. One symbol can be advanced by supplying 20 pulses to the motor. The CPU 31 counts the number of pulses to be supplied to the motors 51, 52, and 53. Count results are retained as position data MD1, MD2, and MD3. Values of the position data MD1, MD2, and MD3 are reset at timings at which the detection signals 47a, 48a, and 49a become active.

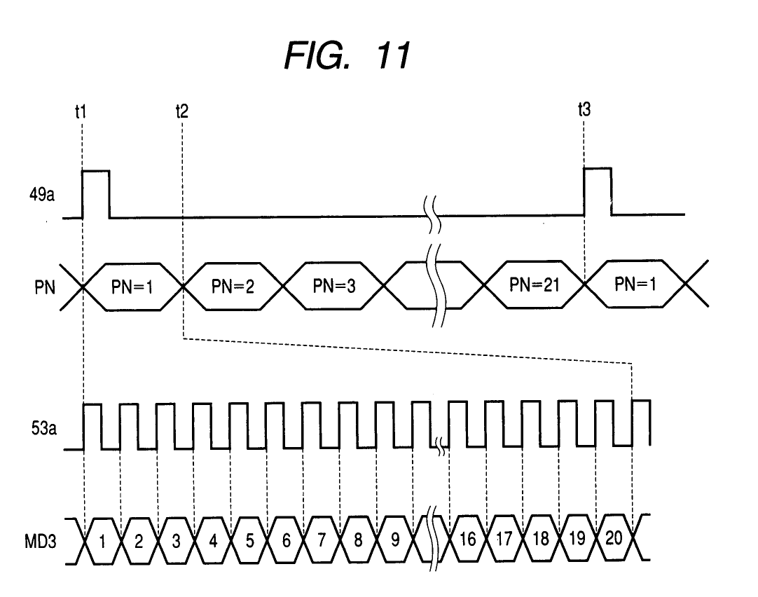

FIG. 11 is a timing chart showing the relationship between the detection signal 49a, the symbol number PN, a drive signal 53a, and the position data MD3. As illustrated, when the detection signal 49a rises from a low level to a high level at time t1, the value of the position data MD3 is reset. At time t1, the shading piece 491 shown in FIG. 2 passes through the photocoupler 492. At this time, in relation to the spinning position of the right reel R3, the symbol assigned symbol number PN=1 (WATERMELON) shown in FIG. 5 is displayed in a middle row of the display window 4c. In other words, attachment positions of the shading piece 491 and the photocoupler 492 are determined such that a symbol appears in the middle row of the display window 4c.

During a duration from time t1 to time t2, 20 pulses are supplied to the left reel drive motor 51 as a drive signal 53a, and the right reel drive motor 53 spins the right reel R3 one-twenty-first of a rotation, As a result, the symbol assigned symbol number PN=2 (BLUE 7) shown in FIG. 5 appears in the middle row of the display window 4c. Symbols are sequentially displayed in the same manner. When time t3 has come, the right reel R3 spins once, and the symbol assigned symbol number PN=1 (WATERMELON) appears. In this way, the detection signal 49a, the symbol number PN, the drive signal 53a, and the position data MD3 are closely related to each other. The CPU 31 can detect a displayed state of a symbol on the basis of the position data MD3.

On the basis of the position data sets MD1 and MD2, the CPU 31 can sense a displayed state of a symbol on the left reel R1 and a displayed state of a symbol on the center reel R2.

A voltage signal 21a whose level has been controlled by the CPU 31 is supplied to the reel illumination lamp 21 for a predetermined time period. The reel illumination lamp 21 is interposed between the EL display panel 80 shown in, FIG. 4 and the reels and illuminates the reels R1 to R3 to thereby make the symbols easily readable for the player.

Operation of the slot machine 1 will now be described. Before the player starts playing games, the CPU 31 sends a display command C1 to the display controller 70. The display command C1 is for displaying a demonstration image and includes game history information. Here, the game history information indicates results of past games played on the slot machine. For example, the information corresponds to a total number of games played that day, the number of times wins have arisen for the BB prize, the number of times wins have arisen for the RB prize, and the number of games played since a final win has arisen for the BB or RB prize.

Upon receipt of the display command C1, the display controller 70 produces image data corresponding to a demonstration screen. The image data include data to be used for displaying a history screen produced on the basis of the game history information. The image data also include data to be used for displaying images of the rows of the symbols provided on the respective reels R1 through R3 spinning and coming to a halt. The image data cyclically repeat the same contents. When the image data are supplied to the EL display panel 80, the EL display panel 80 display the play history and images of the reels spinning and coming to a halt. In the following descriptions, the reel images appearing on the EL display panel 80 are referred to as virtual reels.

When the player inserts tokens into the token insert slot 5, the CPU 31 counts the detection signals output from the inserted token detector 41, thereby generating reserved token count data representing the number of reserved tokens. The CPU 31 sends the reserved token count data to the display controller 70. The CPU 72 of the display controller 70 reads, from the ROM 74, the image data to be used for displaying numerals in association with the reserved token count data and displays the number of reserved tokens on the display panel 80.

In accordance with a detection signal output from the inserted token detector 41 and that output from the BET button 42, the CPU 31 performs a bet receiving operation when the player inserts a token or performs a betting operation.

Subsequently, the CPU 31 displays, on the auxiliary display section 20, the winning lines of the winning lines L1 through L5 which have been validated in accordance with the number of tokens inserted or bet by a betting operation. Further, the CPU 31 produces validated line data showing the validated winning lines and sends the validated line data to the display controller 70. The CPU 72 of the display controller 70 reads, from the ROM 74, image data to be used for displaying validated winning lines in accordance with the validated line data and causes the display panel 80 to display the validated winning lines.

There are two alternatives for displaying the validated winning lines. A first alternative is to display an image for masking areas other than areas of the validated winning lines. A second alternative is to display an image showing marks assigned to the validated winning lines. An example of the second method is to blink the validated winning lines or to cause a line to extend from the left side along the validated winning lines and to come to a stop. Accordingly, the player can ascertain validated winning lines from among the winning lines L1 to L5.

Subsequently, in accordance with a detection signal from the start lever sensor 43, the CPU 31 determines whether or not the player has validly actuated the start lever 6.

When actuation of the start lever 6 is valid, the CPU 31 supplies the drive signal 51a to the left reel drive motor 51 so as to start spinning of the left reel R1, supplies the drive signal 52a to the center reel drive motor 52 so as to start spinning of the center reel R2, and supplies the drive signal 53a to the right reel drive motor 53 so as to start spinning of the right reel R3. In accordance with the control program CP, the CPU 31 performs an internal lottery operation.

Internal lottery operation is performed in the following manner. First, the CPU 31 executes sampling of count data CD at a timing at which a detection signal output from the start lever sensor 43 has become active, to thereby acquire sampled data SD. Second, the CPU 31 generates internal selection data ISD by reference to the prize group lottery table TBL1 stored in the ROM 35. For instance, FIG. 7 shows contents stored in the prize group lottery table TBL1. When the value of the sampled data SD is assumed to have a value of '150,” the internal lottery data SD represent a win for a BB prize.

When the internal lottery operation has been completed, the CPU 31 determines whether or not a win has been determined for any prize, on the basis of the internal sampling data ISD. When the result of determination is YES, the CPU 31 starts notifying operation. In connection with the notifying operation, the CPU 31 determines whether to perform notifying operation by internal lottery.

If the result of lottery indicates that notifying operation is to be performed, the CPU 31 lowers the level of the voltage signal 21a from that in an ordinary state. As a result, the light of the reel illumination lamp 21 becomes dimmed, thereby reducing internal luminosity of the housing. Simultaneously, the CPU 31 produces a display command C2 and sends this display command C2 to the display controller 70 along with the internal sampling data ISD. The display command C2 is a command for instructing reporting of the result of internal sampling operation. Subsequently, the CPU 72 of the display controller 70 reads, from the ROM 74, image data corresponding to the prize group for which a win has been determined, on the basis of the internal sampling data ISD. The CPU 72 causes the EL display panel 80 to display a notification image. For instance, when a win has arisen for the BB prize, “7” is displayed across the entire screen. By viewing this display, the player can ascertain occurrence of the BB prize. Here, the degree of reliability may be changed in accordance with the size or color of the character to be displayed (“7” in this embodiment).

The internal brightness of the housing is reduced when the notification image is displayed on the EL display panel 80 so as to become darker than that in a case where no screen display, in order to make the notification image noticeable, to thereby make the screen easily readable for the player.

The advantage of providing a notification through use of the EL display panel 80 is as follows. First, display of the notification image is started when a win for any prize has been determined through internal lottery. Hence, by glancing at the panel display section D, the player can ascertain that a win has arisen for any prize. Second, this mode of report enables a reduction in a distance over which the of the player's gaze is shifted, thereby diminishing the player's eyestrain.

Determination of a win for a prize has hitherto been notified by use of a notification device attached to an upper section of the slot machine 1. However, the player who is playing games stares at symbols appearing in the respective display windows 4a, 4b, and 4c. The notification of determination of a win for a prize is a notification of conditions advantageous for the player in acquiring a win. For this reason, the notification attracts the player's attention during the course of games, and the player shifts his/her gaze to the notification device, thereby ascertaining whether or not a notification has been issued. In the case of an impatient player, the player shifts his/her gaze to the notification device from the panel display section D for ascertaining a notification for each game. In this way, frequent shifting of his/her gaze places strain on the player's eyes within a short time period, thereby hindering the player from enjoying games for a long time period.

In this regard, according to the embodiment, a specific image appears in the panel display section D, at which the player stares during the course of a game. Hence, the player does not need to shift his/her gaze, and the player can enjoy playing games over a long time period without experiencing eyestrain.

The notification image is displayed for only a predetermined time period after the player has actuated the start lever 6. In this case, display of the notification image may be limited to a time at which the player actuates any of the reel stop buttons 7a, 7b, and 7c. In order to limit the number of games to be played per unit time, actuation of the reel stop buttons 7a, 7b, and 7c is invalidated until lapse of a given time period after the player has actuated the start lever 6. Therefore, a notification image may be displayed for a time period during which actuation of the reel stop button is invalidated.

When any prize has not been determined through internal lottery, the notifying operation is not performed. The CPU 31 acquires a button number BN assigned to a currently-pressed reel stop button. Acquisition of a button number is performed in accordance with the following procedures. First, the CPU 31 assigns button numbers BN=1, BN=2, BN=3 to the left reel stop button 7a, the center reel stop button 7b, and the right reel stop button 7c, respectively. Second, the CPU 31 detects a pressed button in accordance with a detection signal output from the left reel stop button 44, a detection signal output from the center reel stop button 45, and a detection signal output from the right reel stop button 46. Third, the CPU 31 stores the button numbers BN corresponding to the detected buttons into a predetermined memory location of the RAM 34 specified by the control program CP.

Next, in accordance with the internal lottery data ISD and the button number BN, the CPU 31 selects one stop table from the stop table group TBL2. In short, three stop tables are selected to stop the respective reels R1, R2 and R3.

The CPU 31 determines stop positions of the reels by reference to the thus-selected stop table. In the processing for determining stop positions of the reels, the CPU 31 senses the timings at which the reel stop buttons 7a, 7b, 7c have been pressed, in accordance with the signals output from the reel stop button sensors 44 through 46, thereby acquiring symbol numbers PN assigned to the timings. The CPU 31 reads stop data by reference to the stop table in accordance with the symbol number PN, thereby controlling the reel drive motors 51 through 53 such that the reels spin by only the number of frames over which the reels are to coast, the number being instructed by the data. The reel drive motors 51 through 53 are constituted of stepping motors, and the CPU 31 imparts, to the reel drive motors 51 through 53, drive pulses in a number corresponding to the number of frames over which frames are to coast.

Subsequently, a determination is made as to whether or not all reels have stopped until all spinning reels come to a halt.

During a period from the time the reels R1 to R3 have started spinning simultaneously until all the reels R1 to R3 have come to a halt, a presentation screen may be displayed on the EL display panel 80 in the following manner.

The first manner is display of winning lines along which a win may arise. For instance, it is assumed that the player has validated all the winning lines L1 through L5 and actuated corresponding reel stop buttons in order from left to right, whereby occurrence of the BELL prize is instructed by the internal sampling data ISD. Here, the left reel R1 is presumed to have come to a halt such that the symbol of the BELL is displayed in a lower row. In this case, the winning lines L3 and L5 are possible lines along which a win may arise. However, one winning line involving a probability of occurrence of a win is determined by the selected stop table. Hereinafter, a winning line, which is determined to have a probability occurrence of a win on the basis of the result of selection made according to the stop table, will be called a “win-expected payline.” On the basis of a result of selection performed according to the stop table, the CPU 31 specifies a win-expected payline. The thus-specified win-expected payline is displayed on the EL display panel 80.

Specifically, when the set of stop tables has been selected through first stopping action, the CPU 31 produces win-expected payline data, by which the win-expected payline is instructed in accordance with the result of selection. The thus-produced win-expected payline data are sent to the display controller 70. The CPU 72 of the display controller 70 reads, from the ROM 74, image data which enable the win-expected payline to be distinguished from the other validated winning lines, thereby causing the EL display panel 80 to display the win-expected payline. For instance, when the validated winning lines are displayed in blue, a win-expected payline may be displayed in red. Alternatively, the display regions other than the display region where the win-expected payline is to be displayed may be masked.

Second, when two symbols which would partially constitute a winning combination for the win determined through internal lottery operation are aligned along the validated winning line by first and second stopping actions (this state will be hereinafter referred to as a win-waiting state), a target symbol is displayed on the EL display panel 80 while being elongated longitudinally. During a control operation for stopping the reels through use of the stop table, target symbols can be stopped through draw-in operation even when the reel stop buttons have been actuated early. In other words, no difference arises in a game result between when the reel stop buttons are actuated within the draw-in range and when the reel stop buttons are actuated when the target symbols are located within the winning positions. Hence, when a win-waiting state has arisen, the EL display panel 80 is caused to display elongated images of the target symbols within the draw-in range in synchronism with the spinning reels.

Specifically, on the basis of the internal sampling data ISD and the positions where the reels have come to a halt as a result of the first and second stopping actions, the CPU 31 determines whether or not a win-waiting state has arisen. When the win-waiting state has arisen, a display command C3 is sent to the display controller 70. The display command C3 includes the internal sampling data ISD showing the kinds of target symbols, the number of frames of a range in a stop table where the target symbols are to be drawn, the table being used for the third stoppage operation, and synchronization information showing the rotational phase of the target symbols.

When the display controller 70 receives the display command C3, the CPU 72 of the display controller 70 reads, from the ROM 74, image data representing target symbols. The thus-read image data are subjected to image conversion processing, wherein the images are elongated longitudinally in accordance with the number of frames which are to appear in the draw-in range, to thereby produce converted image data. The thus-converted image data are stored in the RAM 73. On the basis of the synchronization information, the CPU 72 reads the converted image data from the RAM 73 in synchronism with spinning of the reels. The thus-read image data are supplied to the EL display panel 80. As a result, the elongated images of the target symbols are displayed within the draw-in range on the EL display panel 80 in synchronism with the spinning reels. The player can actuate the reel stop buttons while viewing the elongated symbol images. Even a low-skill player can readily stop the target symbols targets at desired positions The presentation processing is completed when the player has actuated the final reel stop button, and the EL display panel 80 returns to an ordinary translucent state.

Third, when a win-waiting state has arisen as a result of the first and second stopping actions, target symbols are displayed on the EL display panel 80 at the positions where the target symbols would constitute a win. The target symbols are displayed so as to become gradually larger for a time period during which spinning positions of the reels approach from positions where the target symbols can be drawn up to winning positions.

Specifically, on the basis of the internal sampling data ISD and the positions where the reels have come to a halt as a result of the first and second stopping actions, the CPU 31 determines whether or not a win-waiting state has arisen. When the win-waiting state has arisen, a display command C4 is sent to the display controller 70. The display command C4 includes the internal sampling data ISD showing the kinds of target symbols, the number of frames of a range in a stop table where the target symbols are to be drawn, the table being used for the third stoppage operation, and synchronization information showing the rotational phase of the target symbols.

When the display controller 70 receives the display command C4, the CPU 72 of the display controller 70 reads, from the ROM 74, image data representing target symbols. The thus-read image data are subjected to image conversion processing, wherein the images are enlarged or reduced, to thereby produce a plurality of converted image data sets. The thus-converted image data are stored in the RAM 73. On the basis of the synchronization information, the CPU 72 sequentially reads the converted image data from the RAM 73 in synchronism with spinning of the reels. In this case, the image data are read such that images become sequentially greater in size. When the number of frames in the draw-in range are finished (i.e., the target symbols have spun past the winning positions), image data to be used for displaying the smallest images are supplied to the EL display panel 80. As a result, the sizes of the target symbols can be changed within the draw-in range in synchronism with the spinning reels. Therefore, even a low-skill player can readily stop target symbols at desired positions. The presentation processing is completed when the player has actuated the final reel stop button, and the EL display panel 80 returns to an ordinary translucent state.

When all the reels R1 to R3 have come to a standstill, a presentation screen may be displayed on the EL display panel 80 in the following manner.

First, after all the reel R1 through R3 have come to a halt, the stationary symbols are displayed on the EL display panel 80, thereby displaying spinning images of virtual reels. Here, the virtual reels signify reel images imitating the reels R1 to R3, and symbols are provided on the imitating reels in the same manner as on the real reels, In this case, the start lever 6 and the reel stop buttons 7a, 7b, and 7c are validated, and the virtual reels are stopped at the timings at which the player has actuated the reel stop buttons. Specifically, a replay game using the virtual reels is performed. In the replay game, the internal random sampling and control operation for stopping the virtual reels using the stop table are performed.

Specifically, the CPU 31 determines whether or not a win has arisen while the reels R1 through R3 remain stationary. If a failure has arisen, a display command C5 is produced and transmitted to the display controller 70. The display command C5 includes information representing stop positions of the respective reels R1 through R3, a timing at which the start lever 6 is to be actuated during the replay game, and information indicating positions at which the virtual reels are to come to a halt during the replay game. The information indicating the stop positions is imparted in the form of symbol numbers assigned to symbols which are to appear in the middle row in a stationary state.

When the display controller 70 receives the display command C5, the CPU 72 of the display controller 70 causes the EL display panel 80 to display virtual reels in the stationary state on the basis of the symbol numbers. Variable display of the symbols is started at a timing at which the player has actuated the start lever 6. On the basis of the symbol numbers indicating the stop positions of the virtual reels, the variable display of the reels is stopped. The result of the replay game may be or may not be reflected on imparting of a gaming value. The symbols may be arranged on the virtual reels in the same pattern as those on the reels R1 through R3 or in a special, different pattern.

Secondly, in a stationary state, some or all of the symbols provided on the reels R1 through R3 are displayed as images on the EL display panel 80. Animation to be used for moving the images of the symbols is displayed.

Specifically, the CPU 31 produces a display command CG and sends the display command C6 to the display controller 70. The display command C6 includes information indicating the stop positions of the respective reels R1 through R3. When the display controller 70 receives the display command C6, the CPU 72 of the display controller 70 specifies the layouts of the symbols for a stationary state on the basis of the information indicating the stop positions. Symbols to be displayed in the form of animation are determined through sampling, and the symbols are switched to an animation display.

Third, when a win has been determined through any winning combination, target symbols appearing on the winning line are displayed in the form of enlarged or reduced images.

Specifically, the CPU 31 produces a display command C7 and sends the same to the display controller 70. The display command C7 includes information to be used for specifying winning lines and information to be used for specifying the kinds of target symbols. When the display controller 70 receives the display command C7, the CPU 72 of the display controller 70 causes the EL display panel 80 to display enlarged or reduced images of the target images along the winning line specified on the basis of the display command C7. As a result, the player can ascertain occurrence of a win.

Fourth, when a win-waiting state has arisen, the EL display panel 80 is caused to display only the target symbols, thereby variably displaying the target symbols while moving the symbols longitudinally and laterally in the form of a matrix pattern. The operations described thus far correspond to presentation processing which is to be performed through use of the EL display panel 80 after stoppage of the reels R1 through R3.

Subsequently, the CPU 31 determines whether or not the win corresponds to a win involving payment of tokens. If the win corresponds to the win involving payout of tokens, the CPU 31 controls individual sections such that tokens are paid out in a number corresponding to the winning combination, by reference to the win determination symbol combination table TBL3. Incidentally, the number of tokens to be paid out may be displayed in the EL display panel 80.

If the win does not correspond to payout of tokens, the CPU 31 determines whether or not there has been achieved a win corresponding to any one of the bonus games, such as a regular bonus, a normal big bonus, and a super big bonus. If the win corresponds to any one of the bonus games, the CPU 31 performs predetermined processing for advancing the bonus game. In this case, information regarding the bonus game may be displayed in the EL display panel 80. Such information include activation, termination or proceeding condition of the bonus game.

In contrast, if the win does not correspond to any bonus game, the CPU 31 determines whether or not the win is a REPLAY game. If the symbols that would constitute a winning combination are symbols which would constitute a PLUM winning combination, the CPU 31 validates the operation of the start lever 6 to execute the above operation. If the symbols are not symbols which would constitute a PLUM winning combination, a round of processing operations is terminated.

The invention has been described in association with embodiments which are considered to be most practical and preferable at this point in time. However, the invention is not limited to the embodiment described in the specification and is susceptible to modifications, as required, that fall within the scope of the gist or concept of the invention read from claims and the entire specification. A slot machine involving such modifications must be construed to fall within the technical scope of the invention. For instance, as a matter of course, modifications provided below fall within the scope of the invention.

In the above embodiment, a special symbol specifically designed for changing display of the EL display panel 80 may be provided on at least one of the reels R1 through R3. In this case, when the special symbol has come to a halt any one of the winning lines, switching to display of the EL display panel 80 is effected, and an image which changes the special symbol to another symbol is displayed on the EL display panel 80 at the position where the special symbol has stopped.

More specifically, the CPU 31 produces a display command C8 and sends the command to the display controller 70. The display command C8 includes information indicating the stop position of the special symbol. When the display controller 70 receives the display command C8, the CPU 72 of the display controller 70 specifies the layout of the special symbol in a stationary state on the basis of the information indicating the stop position and causes the EL display panel 80 to display an image which changes the special symbol.

The slot machine may adopt an AT game. Here, the AT game is a game for notifying the type of a small winning combination for which a win has been determined through internal lottery and a sequence in which the reel stop buttons 7a, 7b, and 7c are to be pressed or positions where stopping actions are to be performed, both being suitable for causing the selected small winning combination to achieve a win. When the sequence in which the reel stop buttons are to be pressed is notified, a display region of a reel, which is an object of pressing action, may be made transparent. Display areas of the other reels may be made translucent. Similarly, when positions where the stopping actions are to be performed are reported, the display region of the reel which is an object requiring a stop operation position is made transparent, and display areas of the other reels are made translucent.

In this case, the translucent area may be translucent to such an extent that the player can discern symbols displayed on the reel during spinning.

What is claimed is:

1. A gaming machine, comprising:
a plurality of rotatable reels, each provided with a plurality of symbols;
a window, through which the reels are looked;
an electro-optical member, disposed between the window and the reels, the electro-optical member being transparent with respect to visible light, but operable to display an electro-optical image in accordance with an electric signal supplied thereto; and
a controller, which controls the electric signal thereby controlling the electro-optical image to be displayed in the electro-optical member.

2. The gaming machine as set forth in claim 1, wherein the electro-optical member comprises a pair of transparent substrate between which an electro-optical substance is sandwiched.

3. The gaming machine as set forth in claim 1, wherein the electro-optical image includes gaming information generated in accordance with a proceeding condition of a game performed in the gaming machine.

4. The gaming machine as set forth in claim 1, further comprising an illuminator, which illuminates the reels under with at least a first luminosity and a second luminosity darker than the first luminosity,
wherein the illuminator illuminates the reels with the second luminosity when the electro-optical image is displayed in the electro-optical member.

5. The gaming machine as set forth in claim 1, further comprising a detector, which detects a position of at least one of the symbols on at least one of the reels looked through the window,
wherein the controller controls the electro-optical image in accordance with the detected position.

6. The gaming machine as set forth in claim 7, wherein the position is detected with reference to a rotation angle of the at least one reel.

7. The gaming machine as set forth in claim 5, wherein the electro-optical image shows at least one reel rotated in accordance with the detected position in a case where at least one of the reels is stationary.

8. The gaming machine as set forth in claim 5, wherein the electro-optical image shows transformation of the detected symbol into another symbol in accordance with the detected position in a case where at least one of the reels is stationary.

9. The gaming machine as set forth in claim 5, wherein:
the controller comprises a first controller and a second controller; and
the first controller generates information regarding the detected position and transmits the information to the second controller so that the second controller controls the electro-optical image.

10. The gaming machine as set forth in claim 6, wherein:
the controller comprises a first controller and a second controller; and
the first controller generates information regarding the rotation angle and transmits the information to the second controller so that the second controller controls the electro-optical image.

11. The gaming machine as set forth in claim 9, wherein the first controller generates information regarding the detected position and transmits the information to the second controller so that the electro-optical image shows at least one reel rotated in accordance with the detected position, in a case where at least one of the reels is stationary.

12. The gaming machine as set forth in claim 9, wherein the first controller generates information regarding the detected position and transmits the information to the second controller so that the electro-optical image shows transformation of the detected symbol into another symbol in accordance with the detected position, in a case where at least one of the reels is stationary.

13. A method of controlling a gaming machine, comprising step of:
providing a gaming machine which comprises:
a plurality of rotatable reels, each provided with a plurality of symbols;
a window, through which the reels are looked; and
an electro-optical member, disposed between the window and the reels, the electro-optical member being transparent with respect to visible light, but operable to display an electro-optical image in accordance with an electric signal supplied thereto;
detecting a proceeding condition of a game performed in the gaming machine; and
controlling the electric signal in accordance with the detected proceeding condition, thereby controlling the electro-optical image to be displayed in the electro-optical member.

14. The method as set forth in claim 13, further comprising step of:
providing an illuminator in the gaming machine, the illuminator being operable to illuminate the reels under with at least a first luminosity and a second luminosity darker than the first luminosity; and
controlling the illuminator so as to illuminate the reels with the second luminosity when the electro-optical image is displayed in the electro-optical member.

15. The gaming machine as set forth in claim 13, further comprising steps of:
detecting a position of at least one of the symbols on at least one of the reels looked through the window; and
controlling the electro-optical image in accordance with the detected position.
